(19) United States
(12) Patent Application Publication
(10) Pub. No.: US 2018/0307453 A1
(43) Pub. Date: Oct. 25, 2018

(54) INTERACTIVE MULTIMEDIA DEVICE

(71) Applicant: TOMI WORLD LDA, Viseu (PT)

(72) Inventor: José Manuel Simões Agostinho, Viseu (PT)

(21) Appl. No.: 16/023,482

(22) Filed: Jun. 29, 2018

Related U.S. Application Data
(63) Continuation-in-part of application No. 15/188,036, filed on Jun. 21, 2016, now abandoned.

(51) Int. Cl. G06F 3/147; G06F 3/044

(52) U.S. Cl. CPC G06F 3/147; G06F 3/044; G09G 2360/144; G09G 5/10; G09G 2354/00; G09G 2370/022; G09G 2320/0626

(57) ABSTRACT

The present invention refers to an interactive multimedia kiosk with a touch-sensitive (touch-screen) system to be integrated as urban furniture, specially outdoors, with online interactive contents about the latest news and promoting the economy, culture and tourism of the region where the device is installed, characterized by disclosing a structure comprising:
a physical structure in aluminium with electrostatic paint finish in black lacquer with anti-graffiti treatment;
full glass faces (front and rear), laminated and tempered with 4+4 mm;
55″ screen with light sensors and an integrated PC;
Foiltouch “55” Projected capacitive film, placed behind the glass face;
digital cameras;
which also includes an activated alarm system with remote monitoring and control capabilities through mobile network;
and a hidden cooling system.

### BACKGROUND OF THE INVENTION

The present invention refers to an urban mobility device with the latest news and which promotes the economy, culture and tourism of the location where it is installed. It can be defined as an online interactive kiosk that supports all users who attend or visit the City, or geographically defined locations or regions. With the device described by the present invention, it is intended to create a solution that values the kiosk element for being an effective means of communication with added value to the citizen/visitor, where there are many points of interest available, like Museums, Pharmacies, Restaurants, Coffee Shops, locations of day/night entertainment, allowing return of the investment with the inclusion of advertisement content.

The structure of the kiosk described by the present invention is prepared for its installation and operation to endure in public outdoors environment. Therefore the structure should include a cooling system (air conditioning or ventilation) to control temperature inside the equipment, as well as a light sensor to adjust screen brightness adapted to the ambient light intensity. The equipment paint job is prepared for several situations of vandalism, thus including anti-graffiti paint.

The device is based on a hardware solution that enables one to provide, on an outdoors environment, a kiosk with a 55″ screen with an integrated PC, the same device being permanently connected to a network with internet access. The various kiosks should be managed and updated through a centralized server with a fixed IP and should still be based on technology.

The management platform adapted to the operation of the device allows the user to manage the entire network of kiosks in a centralized manner, thus allowing
to monitor the status of each kiosk (online, offline, error, etc.).
to restart an offline kiosk or a kiosk with error by an IP communications independent switch;
to schedule the shutdown and the power-up of the kiosk;
to schedule synchronizations with the kiosks;
to emit usage reports per kiosk, group or network;
to customize permissions per user.

The Device/Kiosk presents a set of functionalities that fall within the scope of its applicability. The application interface of the kiosks presents, however not being restricted to, the following main areas:
Advertising Channel, which allows the addition of various formats (video and image);
Directory—Allows the user to find several points of interest and calculate routes; to book hotels or restaurants, in this case the user being asked to insert some data (name+phone number+date+time) and an email being sent to the entity that will confirm the reservation by telephone contact with the user;
News;
Schedule;
Information—Especially suited to public transport in the city.

Any one of the menus is activated/controlled by the user through the pan & scroll system, whenever the user wishes to do so. The user can also select the language in which he wants to consult the device.

### BRIEF DESCRIPTION OF THE DRAWINGS

FIG. 1—Represents the front view of the Device/Kiosk.

FIG. 2—Represents the side view, corresponding to the real thickness of the device/kiosk

FIG. 3—Represents the rear view of the device/kiosk.

FIG. 4—Represents the perspective view of the device/kiosk.

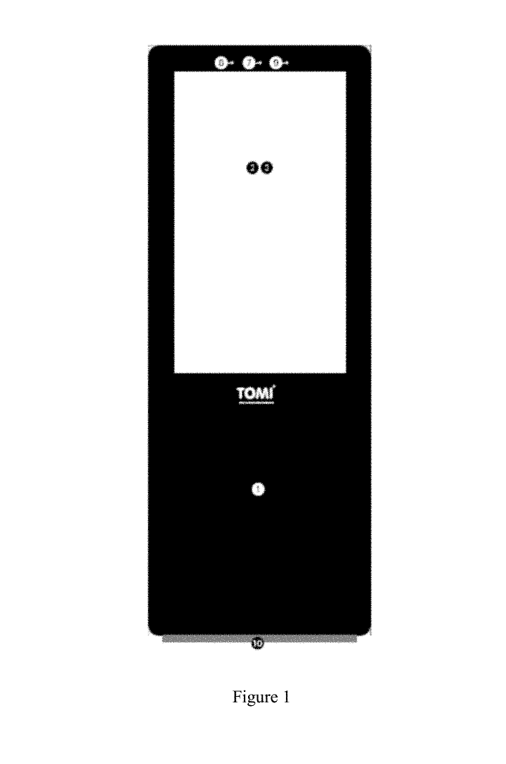

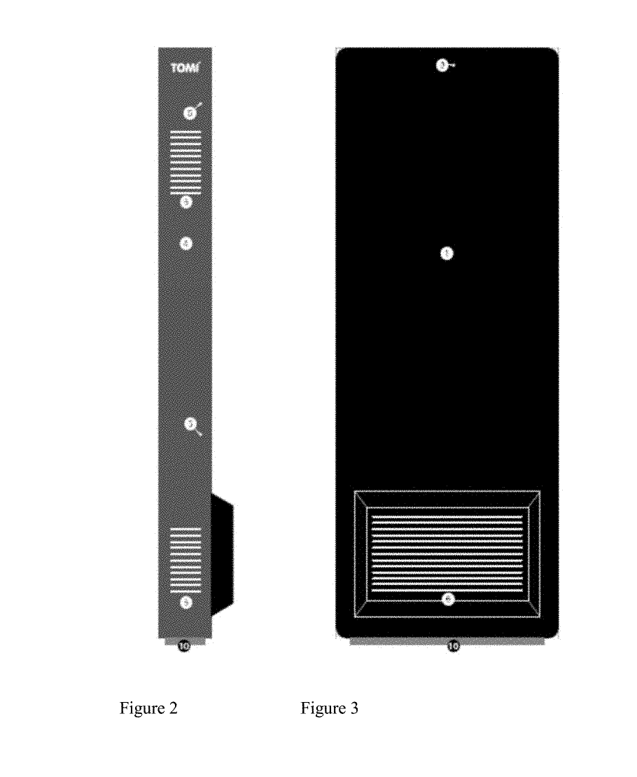

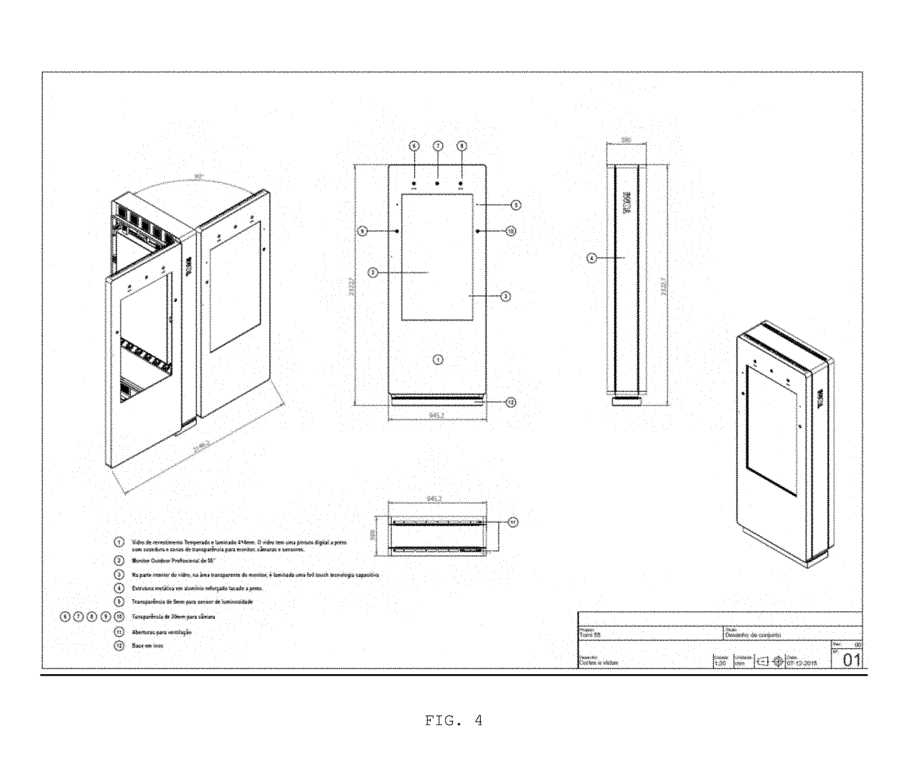

### DETAILED DESCRIPTION

The present invention refers to an interactive multimedia Device/Kiosk, multi-touch because of its pan & scroll system, to be integrated as urban furniture, especially outdoors, characterized by being composed of:
a physical structure in aluminium with electrostatic paint finish in black lacquer with anti-graffiti treatment;
full glass faces (1) (front and rear), laminated and tempered with 4+4 mm thickness;
55″ screen (2) with ambient light sensors and an integrated PC;
Foiltouch 55″ Projected capacitive film (3), placed behind the glass face;
digital cameras—up to 5 located on each face of the device (6 . . . 10);
and a cooling system.

The front region of the device/kiosk is covered with glass (1) laminated and tempered with 4+4 mm, the rear glass being retro painted with black baking and with transparent areas adapted to the graphic areas, and wherein the cameras are installed (digital (7 and 8) and video surveillance and alarm (9)). The display (2) present in the front region is a 55″ screen with ambient light sensors, and, in the area of the screen, a Projected Capacitive Foiltouch 55″ coating film (3) is placed behind the glass (1).

The side faces are covered with plate (4) painted in black, wherein there are two holes (5) corresponding to the lock of the Device. The need to incorporate a cooling system causes two sets of fissures (11) to exist, one near the top and the other near the base, for ventilation of the aforementioned equipment.

The rear region of the device/kiosk is, just like the front region, covered by glass (1) laminated and tempered with 4+4 mm, the glass being retro painted with black baking with transparent areas wherein is installed the alarm camera (9) and a set of fissures (6) with an height of about 8 mm near the base, for ventilation of the cooling equipment.

There is also a stainless steel metallic base (12) to support the kiosk.

### PREFERRED APPLICATION OF THE INVENTION

### Example—Preferred Technical Requirements

| | | |
|---|---|---|
| Panel | Diagonal | 55″ |
| | Type | LED Screen |
| | Resolution | 1920×1080 minimum |
| | Brightness (Typ.) | 3000 cd/m² |
| | Visualization angle (H/V) | 178°/178° |
| Connectivity | Video Inputs | HDMI (x2)/DP/DVI |
| | Network | RJ45 |
| Power | Power Consumption (Typ/MAX) | 230 W/310 W |
| | Power Consumption on | 100 W |
| | Stand-By (MAX) | AC 100-240 V ~(±10%), 50/60 Hz |
| | Power Source | |
| Mechanical | Dimensions (H × W × D) | 91.4″ × 37.2″ × 15.0″ |
| Specifications | Bezel Width | 83 mm (Housing) |
| | Protection Glass | Included (5t) |
| Operation | Operation Temperature | TBD |
| | Moisture | TBD |
| | MTBF | 50,000 Hours |
| | Norms | Security: UL, CSA, NOM |
| | | EMC: FCCErgonomics & |
| | | Environments (optional): TCO |
| | | ′95, TCO ′98 |
| Network Features | Special Features | Built-in Cooling System |
| | Operating System | Embedded Windows |
| | CPU | Intel Core i5-6400 @ 2.70 GHz |
| | Memory | 4 GB |
| | Ethernet | 3 USB |
| | USB | 1 VGA Out + HDMI + DVI |
| | VGA Out | Kingston SSD |
| | HDD | |
| Eco-Management | Standard Emission | EMC |
| | RoHS/Energy Star | N |
| | Product Recyclability | CCFL backlight contains |
| | Package's Recyclability | quicksilver, dispose |
| | | properly |
| | | Recyclable package materials |

What is claimed is:

1. An Interactive multimedia Device/Kiosk with a touch-sensitive system, to be integrated as urban furniture, comprising:
a robust physical structure in aluminium with electrostatic paint finish and anti-graffiti treatment;
full glass faces (front and rear), laminated and tempered with 4+4 mm anti-glare finishing;
the Device having a streamlined monolithic design, with hidden security locks and hidden ventilation grills;
a 55″ screen with ambient light sensors for auto-dimming and an integrated PC;
a Foiltouch 55″ Projected capacitive film, placed behind the glass face;
up to 5 digital cameras on the front and rear sides;
an embedded control system equipped with an automatic connection to a mobile network, allowing the remote monitoring and control of the Device, including an active alarm system including a video surveillance camera;
and a hidden climatization system.

2. The Interactive multimedia Device/Kiosk with a touch-sensitive system, according to claim 1 characterized by being presented, preferably, in outdoor public environments.

3. The Interactive multimedia Device/Kiosk with a touch-sensitive system according to claim 1 characterized by presenting a built-in PC permanently connected to a network access to the internet.

4. The Interactive multimedia Device/Kiosk with a touch-sensitive system according to claim 1 characterized by making available a set of functionalities with the latest news and which promote the economy, culture and tourism of the location where it is installed.
